(19) United States
(12) Patent Application Publication
(10) Pub. No.: US 2005/0010751 A1
(43) Pub. Date: Jan. 13, 2005

(54) Method and apparatus for securing pass codes during transmission from capture to delivery

(75) Inventors: Mats Nahlinder, Belmont, CA (US); Thomas Wu, Mountain View, CA (US); Geoffrey Hird, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arcot Systems, Inc. (a California corporation), Santa Clara, CA (US)

(21) Appl. No.: 10/843,681

(22) Filed: May 10, 2004

Related U.S. Application Data
(60) Provisional application No. 60/469,349, filed on May 9, 2003.

(51) Int. Cl. G06F 7/00

(52) U.S. Cl. 713/150; 380/255; 340/5.8

(57) ABSTRACT

A user can securely enter a shared secret such as a pass code code, pass code or combination of symbols, in a generic computing environment, and deliver it securely to the recipient via an arbitrary network. As an example of such environment, pass code codes protecting an ATM card often need to be communicated to a bank's validation system. The pass code can be entered via a Web interface and delivered over the Internet via third-party network operators while never being exposed to intermediaries.

### CROSS-REFERENCE TO RELATED APPLICATIONS

This application claims priority from U.S. Provisional Patent Application No. 60/469,349 filed May 9, 2003 entitled METHOD AND APPARATUS FOR SECURING PASS CODES DURING TRANSMISSION FROM CAPTURE TO DELIVERY which is hereby incorporated by reference, as if set forth in full in this document, for all purposes.

### FIELD OF THE INVENTION

The present invention relates generally to security systems and more particularly to systems where pass codes are used for access to applications and/or data.

### BACKGROUND OF THE INVENTION

It is well know to control access to data, applications, etc., through the use of keys. As used herein, the term “resource” refers to anything that a computer system might control, such as data, an application, a message, a communication channel, equipment, etc. Controlling access might involve controlling, in whole or part, a user's ability to read, write, modify, control, alter, etc., the resource having a controlled access. Control might have multiple attributes, such that a given user might be granted a particular access to a resource under some conditions, but not others. For example, a user A might be allowed to modify a message if the user has certain attributes at some time of day, but not others. As another example, user B might be allowed access to a communication channel to effect a financial transaction, if time-of-day limitations are met, type of transaction limits are met and the transaction amount is within another limitation, but other, looser limitations would apply if the user provided additional authenticating data. It should be understood that a “user” in such systems could be a human user, a user computing device or system, or human operating a computer or device for such purposes.

In a well-designed access control system, a user cannot access a protected feature with less than some amount of effort, computing power and/or time. Thus, although a user with unlimited time and computing power might be able to bypass an access control system, that does not make the system not well-designed. Many access control systems use a cryptographic system to control access.

In a common example, used herein but not limiting, a bank customer will be provided access to his or her financial information and/or be allowed to effect a transaction if the user can provide a pass code associated with the customer's account. Because the pass code could be used in fraudulent transactions, the bank customer has an interest in maintaining control over the pass code. One aspect of the typical network that might cause a bank customer to lose control over the pass code is it that communications might travel over insecure networks.

A networked computing environment with disparate systems and multiple users on widely different and varying computing devices is inherently hard to ensure the security of sensitive data that protects some kind of an individual's secret and personal information. At times, a user must communicate some secret information to another party across networks and servers that none of the parties have any control over. The two parties also have to worry about having their own computing environments being attacked or monitored in different ways.

It would be desirable to overcome the shortcomings of the prior art described above.

### BRIEF SUMMARY OF THE INVENTION

In one embodiment of a pass code system according to the present invention, a user can securely enter a shared secret such as a pass code code, pass code or combination of symbols, in a generic computing environment, and deliver it securely to the recipient via an arbitrary network. As an example of such environment, pass code codes protecting an ATM card often need to be communicated to a bank's validation system. The pass code can be entered via a Web interface and delivered over the Internet via third-party network operators while never being exposed to intermediaries.

A further understanding of the nature and the advantages of the inventions disclosed herein may be realized by reference to the remaining portions of the specification and the attached drawings.

### BRIEF DESCRIPTION OF THE DRAWINGS

FIG. 1 is a block diagram of an overall system wherein the invention might be used.

FIG. 2 is a swim diagram showing interactions between elements shown in FIG. 1.

### DETAILED DESCRIPTION OF THE INVENTION

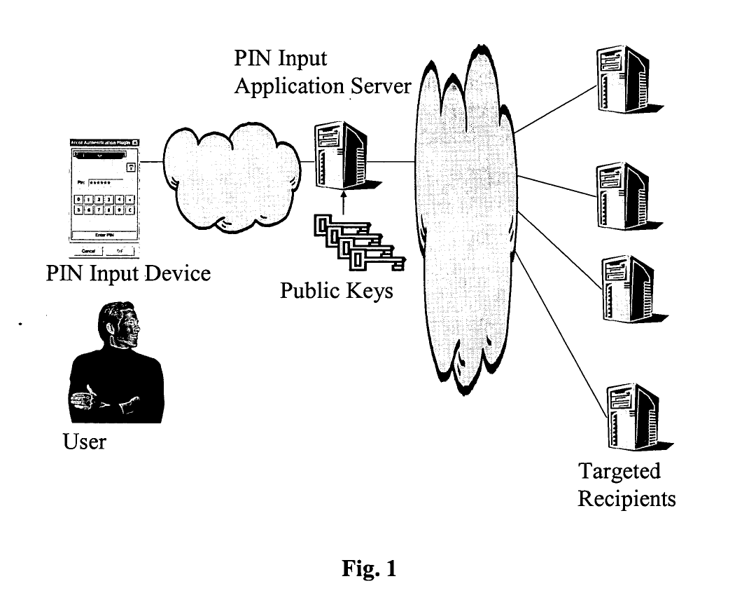

FIG. 1 is a block diagram of an overall system wherein the invention might be used. The overall system is usable to secure a pass code from the time of capture to the time of delivery. As used herein, the term “pass code” might refer to a password, a secret, a secret key, a personal identification number (“pass code”), or the like. The contents of the pass code might comprise one or more elements that could be digits, characters, symbols, etc. The apparatus might be used for entering and delivering a pass code from a user's computing device to a targeted recipient, such as a bank system or an ATM network.

The pass code can traverse one or more third-party (unsecured/unauthorized) domains, without being exposed. The system can also allow for multiple targeted recipients, such that it carries traffic for one targeted recipient that is not decodable by another targeted recipient. Depending on the assessed threat, additional security features can be used to avert attacks.

When an application needs to have a user input a pass code, the application will either direct software, or via redirects request a pass code input application server, to present a pass code entry device to the user. The pass code entry device (pad) might be a software window having a field in which the user types in the pass code. The pass code entry device could also take the form of a graphical pass code pad where the pass code elements are selected using a screen pointer (e.g., a mouse). The pass code pad can also be scrambled at the start of the pass code entry session or after each pass code element is entered. An example of a scrambled pass code pad is that used by Arcot's WebFort system. Another example is shown in U.S. Pat. No. 6,209,102 assigned the present assignee and incorporated by reference herein for all purposes.

When the pass code entry device is to be displayed at the user's computing device (handheld, desktop, laptop, cell phone, etc.), the pass code input application server first identifies that targeted recipient that is to receive the pass code. Once identified, the pass code input application server selects the public key associated with the targeted recipient. This public key is sent to the user's computing device at or near when the pass code entry device is presented to the user. When the user enters the pass code, the pass code is encrypted using the public key. The pass code can either be encrypted after the entire pass code has been entered, or individually as the individual pass code elements are selected. This encrypted pass code is then transferred to the pass code input application server where the encrypted pass code is routed to the intended targeted recipient. At the targeted recipient, the encrypted pass code is then decrypted using the corresponding private key.

For increased security, the pass code can be augmented with additional security factors at the user's computing device prior to encryption with the targeted recipient's public key. For example, an additional factor may be a signature produced by an external security token, such as an ArcotID system or smart card, or other information that is stored on the user's computing device, such as a browser cookie.

In the case of browser cookies, using the above techniques improves security over conventional methods. Normally, a browser sends cookies directly to a Web server such that they can be read by anyone with access to the traffic, including the pass code input application server itself, weakening the security of any system based on the secrecy of such cookies. However, it is possible through setting of certain cookie attributes (i.e., “path”) to allow the pass code entry device to access the cookie and encrypt it along with the pass code, yet prevent the browser from sending the “cleartext” cookie to the pass code input application server.

Additionally, the pass code may be augmented with data specific to the current transaction being authorized (such as a transaction ID) to thwart replay attacks.

If the pass code entry device is presented to the user as a “popup” window, the pass code could be presented in a “pseudo-popup” window, which is a floating frame in a browser window.

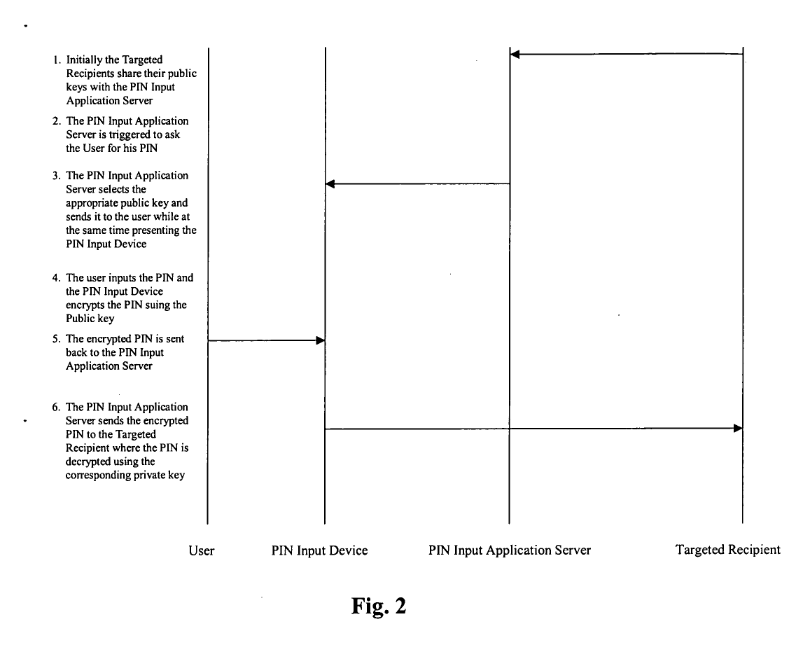

FIG. 2 is a swim diagram showing interactions between elements shown in FIG. 1.

Examples of applications include computer interfaces, web interfaces, database applications, financial systems and their equivalents, as well as other, unmentioned applications capable of being served from an application server.

Not shown are other elements typically found in elements of FIG. 1, such as processors, RAM, ROM, displays, keyboards, mice, network interfaces, hard drives, video processors, etc. Some systems might also include card readers and smart card readers, such as a smart card that contains secrets only accessible by software not entirely controlled by the owner of the system. The processor might execute programs, such as an operating system, and other programs as prompted by the user or as indicated by configuration files stored on the hard drive.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. A pass code transport system comprising:
a user input means for entering a pass code, wherein the user input means is software and/or hardware and the user input means is operated by a user computing device;
a key server that provides public keys of destination recipients to the user input means;
a communications channel for carrying a message comprising at least the pass code encrypted by the public key of a destination recipient for the message, wherein the message could pass through an untrusted network and zero or more intermediate recipients;
wherein the message is not easily decodable at an intermediate point between the user input means and the destination recipient.
